(19) United States
(12) Patent Application Publication
(10) Pub. No.: US 2005/0045797 A1
(43) Pub. Date: Mar. 3, 2005

(54) Interconnecting members with bushing including external threading and tapered end

(76) Inventors: Martin Davies, Essex (GB); Michael D. Skelcher, Essex (GB)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 10/856,973

(22) Filed: May 28, 2004

(30) Foreign Application Priority Data
Jul. 16, 2003 (GB) 0316587

(51) Int. Cl. B25G 3/34

(52) U.S. Cl. 248/650

(57) ABSTRACT

An assembly comprises two structural elements 12, 14 secured firmly to one another while a gap G is maintained between them. The assembly comprises a threaded through bore 18 in the first 14 of the two elements and an externally threaded annular bushing 20 screwed into the through bore 18 and having one end 22 projecting from one of the opposed faces into contact with the other, so as to maintain the desired gap G. A bolt 28 passing through the annular bushing 20 is used to secure the elements 12, 14 to one another. In the invention, the end 22 of the bushing 20 is tapered and is received within a recess 24 of complementary shape in the second element 12 in order to lock the bushing in position.

### FIELD OF THE INVENTION

The present invention relates to a method and apparatus for securing to one another two elements while maintaining a gap between them.

### BACKGROUND OF THE INVENTION

As described in U.S. Pat. No. 6,352,232, it is common to use so-called structural engines in agricultural vehicles, such as tractors, where the engine block forms part of the unsprung mass (or chassis) of the vehicle and is relied upon to assure the structural rigidity of the tractor. To increase the rigidity of such an engine, it is known to secure a substantial oil pan to the underside of the engine block. The oil pan is not only secured to the engine block to collect the lubricating oil circulating through the engine but also acts as a structural element onto which other elements of the tractor chassis such as the front support or the transmission are bolted.

In this situation, because of tolerance stack-up in the manufacture of the engine block, the oil pan and the front support, it is not possible to ensure that the rear face of the front support will always simultaneously lie flush with both the front face of the engine block and the front face of the oil pan. These three elements are therefore intentionally dimensioned such that a gap will always be present between the front support and the oil pan, though the size of the gap may vary from one engine to another.

Conventionally, this gap is taken up by the use of shims, i.e. thin metal spacers that are sandwiched in the gap between the front support and the oil pan before these two are bolted to one another. It is important to select shims of the correct thickness to take up the gap but it is found in practice that incorrect shims are sometimes selected and this results in damage because of the increased stress placed on the elements.

It is also time consuming to select and mount the shims, which adds to the manufacturing costs.

U.S. Pat. No. 6,352,232 teaches a method of bolting elements to one another while maintaining a spacing between them, which dispenses with the use of shims and allows a simple bolting of the elements to one another.

Various possibilities are described in U.S. Pat. No. 6,352,262 for locking a bushing within the bore in a first element, including the use of an anaerobic adhesive, making the bushing shrink-fit in the bore and locking the bushing mechanically in place by the use of a pinch bolt or by the use of one or more sliding wedges that expand the diameter of the bushing during assembly.

### OBJECT OF THE INVENTION

The present invention seeks to provide an improvement over the teaching of U.S. Pat. No. 6,352,262, which dispenses with the need for an adhesive or a lock nut to lock the externally threaded bush in position.

### SUMMARY OF THE INVENTION

In accordance with a first aspect of the present invention, there is provided a method of securing two elements to one another while maintaining a gap between the elements, the method comprising forming a threaded through bore in a first element, screwing an externally threaded annular bushing within the bore of the first element to project from the first element into contact with the surface of the second element, and securing the structural elements to one another by means of a bolt passing through the annular bushing, characterized by the steps of providing a tapering end on the bushing and a complementary tapering recess in the second element to receive the end of the bushing, and tightening the bushing within the threaded bore with sufficient torque to lock the bushing in the bore.

According to a second aspect of the invention, there is provided an assembly comprising two structural elements secured firmly to one another while a gap is maintained between two opposed faces of the elements, the assembly comprising a threaded through bore in the first of the two elements, an externally threaded annular bushing screwed into the through bore and having one end projecting from one of the opposed faces into contact with the other of the opposed faces so as to maintain the desired gap between the opposed faces, and a bolt passing through the annular bushing to secure the elements to one another, characterized in that the end of the bushing is tapered and is locked within a recess of complementary shape in the second element.

In the present invention, as the tapered bushing is driven into the tapered recess, some degree of elastic deformation is experienced by at least one of the bushing and the second structural element so that the bushing is gripped by a clamping force and effectively locked against rotation.

The angle of the wedge is important in that if the wedge is too pointed it can damage the structural element. On the other hand if the conical angle is too great then the desired locking action is not achieved. In practice it has been found that an angle or approximately 30° achieves firm locking, to prevent the bushing from being loosened unintentionally during normal operation, without risking damage to the components.

It is preferred for the bolt acting to secure the two elements to one another to be threaded into the second element and for its head to act on the first element directly rather than against the bushing. To this end, it is desirable for the head of the bushing not to protrude from the through bore so that the head of the bolt may act on the first element either directly or through a washer fitted over the mouth of the through bore.

The head of the bushing is advantageously shaped to receive a spanner or a key that has a smaller outer diameter than the diameter of the through bore so that it can fit in the through bore and enable the bushing to be tightened to the necessary torque even when its head is disposed within the through bore.

By tightening the head of the bolt against the first element rather than against the bushing, a frictional force is maintained between the external thread of the bushing and the internal thread of the through bore further augmenting the forces resisting undesired loosening of the bushing during normal operation.

### BRIEF DESCRIPTION OF THE DRAWINGS

The invention will now be described further, by way of example, with reference to the accompanying drawings, in which:

FIG. 1 is a schematic section through a first embodiment of the invention, and

FIG. 2 is a similar view of an alternative and preferred embodiment of the invention.

### DETAILED DESCRIPTION OF THE PREFERRED EMBODIMENTS

The drawings show schematically the engine 10 and a first member or element, preferably in the form of an oil pan or crankcase 12 of a structural engine of an agricultural tractor connected to a front support 14. The oil pan 12 is a large unit which is bolted to the engine 10 to increase its structural rigidity and both engine 10 and the oil pan 12 need to be bolted securely to the front support 14. The engine 10 mates flush with a second member or element, preferably in the form of a front support. The engine preferably is bolted to the front support via bolts 16. However, because of tolerance stack-up, it is not possible to guarantee that the front face of the oil pan 12 will mate flush with both the front support 14 at one end and a gearbox bell housing (not shown) at the other. For this reason the oil pan 12 is intentionally dimensioned such that there will always be a gap G between it and the front support 14.

Conventionally, the gap G is taken up by shims. In the present invention, a through bore 18 is formed in the front support 14 into which there is threaded a bushing 20 having a conically tapering end 22. The oil pan 12 on the other hand has a conical recess 24 which receives the end 22 of the bushing 20 and leads to a threaded bore 26. A bolt 28 which passes through the center of the bushing 20 is threaded into the bore 26 in the oil pan to secure the oil pan 12 and the front support 14 to one another.

The engine 10 and oil pan 12 are assembled to the front support 14 by first inserting the bolts 16 into the engine 10 and tightening them to the point where the gap G is reduced to its minimum width. Next the bushing 20 is inserted into the bore 18. The head 30 is hexagonal so that it may be gripped by a spanner and tightened to a predetermined torque. Next the bolt 28 inserted through the bushing and engaged in the threaded bore 26 in the oil pan. Last, the bolts 16 and 28 are tightened to predetermined torques to complete the assembly.

Because the end 22 of the bushing 20 and the recess 24 in the oil pan 12 are tapered, tightening of the bushing causes elastic deformation of the wedge and/or the surrounding metal of the oil pan. The deformed metal applies a radial clamping force tending to lock the bushing in the bore 18 during normal use, without the need for a lock nut nor an anaerobic adhesive, as proposed in U.S. Pat. No. 6,352,232.

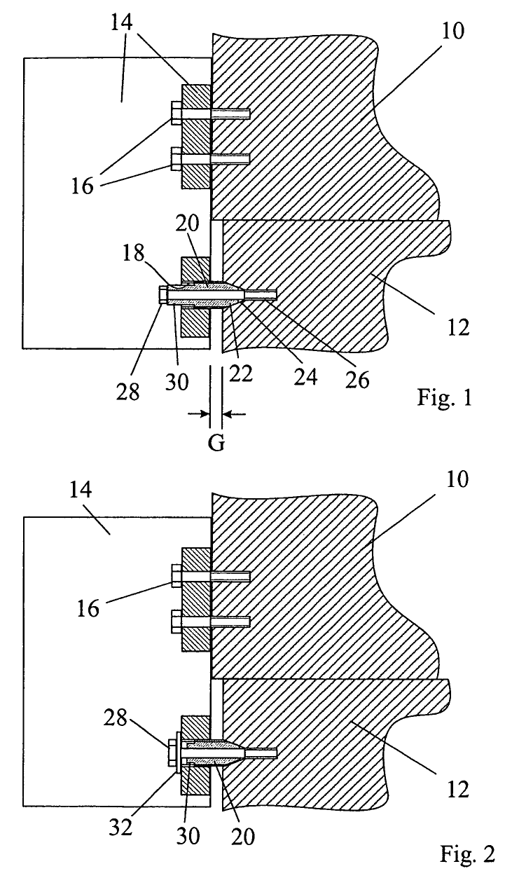

The embodiment of FIG. 2 differs from that of FIG. 1 in that the head 30 of the bushing 20 does not protrude from the bore 18 and in that the head of the bolt 28 does not act on the head of the bushing 20 but on the front support 14 through a suitable washer 32 fitted over the mouth of the bore 18. To allow the bushing 20 to be recessed into the bore 18 it is important that any formation provided to enable it to be gripped by a key or a spanner should not be larger than the diameter of the bore 18. The bushing 20 may for example be formed in the same manner as a grub screw with a non-circular cavity to receive a hexagonal key or a TORX-brand screwdriver.

In the embodiment of FIG. 1, the tightening of the bushing 20 will not only apply a force between the conical surfaces but also on the side of the threads of the bushing facing away from the oil pan 12. However, when the bolt 28 is tightened against the head of the bushing 20, it reduces the force acting on that side of the threads. By contrast, in the embodiment of FIG. 2, the tightening of the bolt 28 increases the force on the side of the threads facing away from the oil pan 12 and therefore increases still further the frictional forces withstanding undesired loosening of the bushing 20.

It will be clear that various modifications may be made to the preferred embodiment without departing from the scope of the invention as set out in the appended claims. For example, in the embodiment of FIG. 2, the head of the bushing may protrude from the threaded through bore as long as the head of the bolt 28 or the intervening washer 32 is shaped to fit over it.

1. A method of securing a structural oil pan to a front support of an agricultural tractor while maintaining a gap between the structural oil pan and the front support, the method comprising the steps of:
forming a threaded bore in the front support;
screwing an externally threaded annular bushing into the bore of the front support so as to project from the front support into contact with a tapering recess in the surface of the structural oil pan, the busing being formed with a tapering end, the tapering recess in the surface of the structural oil pan being shaped complimentary with the tapering end of the busing;
securing the structural oil pan to the front support by means of a bolt passing through the annular bushing; and
tightening the bushing within the threaded bore with sufficient torque for the frictional force between the end of the bushing and the complementary recess in the second element to prevent undesired loosening of the bushing in the bore.

2. An assembly comprising:
a first member forming a threaded bore and including a first face;
a second member including a second face opposed to the first face;
an externally threaded annular bushing screwed into the bore such that one end projects from one of the opposed faces into contact with the other of the opposed faces so as to maintain the desired gap between the opposed faces; and
a bolt passing through the annular bushing to secure the members to one another,
wherein the end of the bushing is tapered and locked within a recess of complementary shape formed in one of the first and second members.

3. An assembly according to claim 2, wherein the bolt acting to secure the two members to one another is threaded into the second member and wherein the head of the bolt acts on the first member directly or via a washer.

4. An assembly as claimed in claim 3, wherein the bushing includes a head, the bore formed by the first member extends through the first member and the head of the bushing does not protrude from the through bore.

5. An assembly as claimed in claim 4, wherein the head of the bushing is shaped to receive a spanner or a key of smaller outer diameter than the through bore.
